(19) United States
(12) Patent Application Publication
(10) Pub. No.: US 2026/0028080 A1
(43) Pub. Date: Jan. 29, 2026

(54) SINGLE-TRACK VEHICLE

(71) Applicant: Guru Technologies GmbH, München (DE)

(72) Inventor: Thomas Leitermann, München (DE)

(73) Assignee: Guru Technologies GmbH, München (DE)

(21) Appl. No.: 18/997,150

(22) PCT Filed: Jul. 19, 2023
(86) PCT No.: PCT/EP2023/069995

§ 371 Date: Oct. 2, 2025

(30) Foreign Application Priority Data
Jul. 20, 2022 (DE) 202022104105.9

(51) Int. Cl. B62J 7/02; B62J 11/04; B62J 43/16; B62J 50/25; B62K 3/00; B62K 11/02; B62K 21/02

(52) U.S. Cl. CPC B62J 7/02; B62J 11/04; B62J 43/16; B62K 3/002; B62K 11/02; B62K 21/02; B62J 50/25; B62K 2204/00

(57) ABSTRACT

In a single-track vehicle with a frame (1), on which are mounted at least one rear wheel (9) by means of a rear wheel holder of the frame (1) and a steering column (12) and a front wheel fork (6) with a front wheel holder (3b) for a front wheel (20) steered by the steering column (12) by means of at least one holder (4; 22) having at least one pivot bearing, and the frame thereof has a foot plate (2), wherein a handle part (8) with which the person steers the vehicle is attached to the steering column (12), and the steering column (12) and the front wheel fork (6) are directly or indirectly coupled to one another, wherein the handle part (8) is firmly connected to the steering column (12), and the frame (1) is designed to extend along the direction of travel, the frame (1) comprises at least one support (13) having a vertical surface and made of a rigid material, which extends in the longitudinal direction of the vehicle and is arranged above the footrest (2) in the region of the steering column (12) or between the steering column (12) and the footrest (2). A front fork holder (22) for the front wheel fork (6) is formed in the region of a lower edge of the support (13), and a steering column holder (4) for the steering column (12) is formed in the region of an upper edge of the support (13). The footrest (2) extends further rearwards than the support (13) in relation to the direction of travel, and the front fork holder (22) and the steering column holder (4) only allow rotational movements of the front wheel fork (6) and the steering column (12) relative to the frame (1), and the support (13) absorbs forces acting horizontally on the front wheel fork (6) and the steering column (12). The footrest (2) is connected to a rear, lower region of the support (13).

### FIELD OF THE INVENTION

The present invention relates to a single-track vehicle on which a person can be transported standing up.

The invention also relates to a frame for single-track vehicles, such as for example scooters, which can transport a person as well as luggage. The luggage can be of different sizes and is secured lengthways to the direction of travel.

The present invention is intended to create a universal luggage holder for such single-track vehicles, which, in order that it can be as stable and light as possible, is integrated together with the front wheel holder and steering column holder in a common frame that is connected to the footboard and the rear wheel holder. The resultant forces should thereby be absorbed as effectively as possible and the structural outlay and weight should also be optimised.

### PRIOR ART

Recently, both human-powered scooters and electrically-powered e-rollers or e-scooters-hereinafter simply referred to as “scooters”-have become more widespread, especially in urban areas and conurbations.

These vehicles are often used as supplementary means of transport for “the first mile” and/or “the last mile”, and are parked somewhere before and after use or are picked up and taken in another means of transport.

In this connection, the available space in the complementary means of transport that is used (e.g. train, car) or in the generally public parking spaces such as in residential buildings, is insufficient. Transporting the scooters up steps into buildings or in and out of the complementary means of transport for example also requires that they have compact dimensions and are lightweight.

Another requirement for scooters if they are used more as a means of transport than as a sports or leisure device, is the ability to carry luggage or loads.

Four types of solutions to this problem have been proposed hitherto:
1. A non-replaceable item of luggage with attachments that is aligned lengthways (e.g. U.S. 9,033,350 B2/ EP2540604B1, EP1138590A1, JP2009006107A, US 2016/0144708 A1, US 2004/0094919 A1, WO 01/72164 A1, CN108791621A) or transversely to the direction of travel (e.g. CN 201240476Y, DE 10026184 C2, EP 3 516 982 A1, U.S. Pat. Nos. 6,460,866, 9,090,274, US20130062377A1). In this case luggage (usually an upright suitcase) contains the attachments needed to convert it into a scooter. They are extended or folded out for riding, and retracted or folded in for carrying. The item of luggage itself is therefore the scooter.
2. A trolley with scooter attachments (such as a footboard) and luggage holder transverse to the direction of travel (e.g. US20150122566A1, trolley with removable suitcase: US20100213680A1). As regards the attachments, the same applies as in 1.
3. A normal scooter with a luggage container on the front wheel transverse to the direction of travel (e.g. DE000010204478A1, DE202019103766U1, US20140061267A1, WO001995008466A1, EP000001704901A1, DE202008006764U1, US20130062377A1, DE102006042119A1) or with a square base (DE202004003741U1, DE102011106561A1)
4. A normal scooter with a luggage container on the front wheel that is open at the top (e.g. DE3138095A1/DE000008128047U1, US20160297459A1, U.S. Pat. No. 8,534,405, DE9403583U1, combination of 3. and 4.: DE000029610975U1, DE102012007780B3, DE102006049770A1)

U.S. Pat. No. 9,108,695 describes a vehicle in which a vertical square frame serves as a luggage holder as well as a central part for holding the steering, front wheel and seat (instead of a footrest), though in this case the luggage is not secured to a surface but instead is slid into the frame.

The solutions involving a fixed item of luggage as well as those involving a luggage holder are less flexible for transporting. In the case of rental scooters, the passenger also brings their luggage with them.

The luggage holder solutions transverse to the direction of travel or with a square base have a disadvantage in terms of space requirements in the case of larger items of luggage. In general, an item of luggage does not have a square base, i.e. a long side. This must be transported pointing forwards for reasons of tipping stability and transverse to the direction of travel for securement stability. Depending on the size of the luggage, this widens the vehicle considerably since it has a rather elongated base, and can be a disadvantage when driving through pedestrian zones for example.

The invention aims to further develop a known type of scooter in such a way that it has a universal luggage rack that can hold various passenger items such as suitcases or shopping bags, while at the same time creating a stable and compact structure for the scooter that has the least possible intrinsic weight.

The closest prior art to this is disclosed in WO 02/12057 A1. This document already shows a single-track vehicle on which a person can be transported standing up. However, the frame acts more as a cover, and increases the stability of the vehicle only when folded up or collapsed, but not however when driving in the unfolded state. In this citation, the front wheel fork is moreover also designed to be foldable and is not directly and firmly connected to the frame. With the corresponding folding construction, as shown for example in FIG. 8 of the citation, sufficient forces cannot be transmitted to act on the overall structure when driving. As a result, the steering column in the citation is not sufficiently firmly connected to the frame.

Based on this prior art, the object of the present invention is therefore to further develop and improve such a single-track vehicle in such a way that the stability when driving is significantly increased, so that the vehicle can also be used by tall and heavy people without any worry.

This object is achieved with the features of claim 1. Further advantageous embodiments are disclosed in the subclaims.

Using a somewhat different terminology, the invention thus provides a single-track vehicle on which a person can be transported standing up, with a steered front wheel with a holder in the form of a front wheel fork, a handle part by means of which the person can steer the vehicle, at least one rear wheel with a rear wheel holder, a steering column, a footrest which is arranged between the front wheel and the rear wheel, and a frame in which the steering column connects the front wheel fork and the handle part, the handle part being firmly connected to the steering column, wherein the frame is designed to be extended lengthways in the direction of travel, the footrest is arranged in the rear lower region of the frame in the direction of travel, wherein the frame comprises a vertical surface made of a rigid material which extends in the longitudinal direction of the vehicle and which is arranged in the longitudinal direction between the steering column and the footrest above the footrest, and on the lower edge of which the front wheel fork is rotatably mounted and on the upper edge of which the steering column is rotatably mounted, while the footrest is connected to the rear, lower region of the surface. In order to limit the length of the vehicle, shift the centre of gravity rearwards and, for stability reasons, maximise the distance between the footrest attachment points on the frame, the frame preferably covers the footrest so that the driver's feet are also positioned below the frame.

The surface can be geometrically so dense and impermeable and the surface structure on this surface so stable that items of luggage can be fastened to it without falling through in a horizontal direction.

It is also preferred that fixing options are arranged on at least two places on the surface, with which items of luggage can be secured.

If larger or heavier items of luggage are to be transported, the surface is preferably closed off at its lower end by a floor platform running horizontally towards the side.

A stand is preferably attached to the rear, lower corner of the surface.

In order to further reduce the spatial requirements of the vehicle according to the invention during transport or storage, the footrest together with the rear wheel is preferably designed to be removable, and fastening means are preferably provided on the surface for vertically attaching the footrest parallel to the lower edge of the surface, with the rear wheel facing downwards.

To further facilitate the transport of the vehicle according to the invention, a horizontally aligned holding device, a stable handle or a holding strap is preferably attached to the upper edge of the surface.

To further improve the stability of the vehicle according to the invention, cross members are preferably arranged between the outer corners of the floor platform and the upper ends of the front and rear side edges of the surface.

Holders for mobile phones or maps or bottle holders can preferably be attached to the upper edge of the surface.

Lockable compartments can also be provided on the surface for the convenience of users.

If the vehicle has an electric drive, batteries can be secured to the surface.

In addition, advertising images and/or advertising inscriptions can be applied to one or both side surfaces of the surface, which are particularly conspicuous and striking since they are displayed everywhere the vehicle according to the invention travels.

### BRIEF DESCRIPTION OF THE DRAWINGS

The present invention is explained in more detail hereinafter with the aid of the exemplary embodiment shown in the attached drawings, in which:

FIG. 1 shows a scooter according to the prior art in solid lines; the additional components according to the invention are shown in dashed lines;

FIG. 2 shows a scooter according to the invention in a side view;

FIG. 3 shows the scooter according to the invention in 3D view;

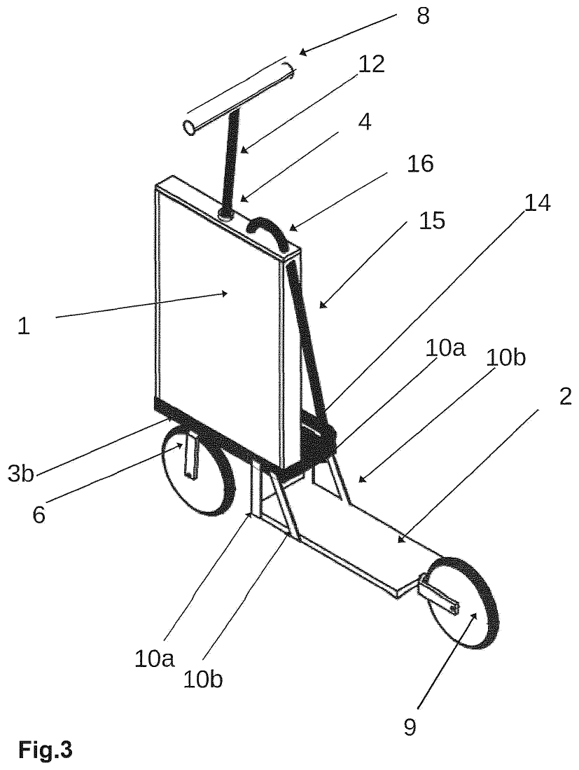

FIG. 4 shows the scooter according to the invention with the luggage rack in 3D view from the rear right;

FIG. 5 shows a variant of the scooter according to the invention with a removable footrest in a side view;

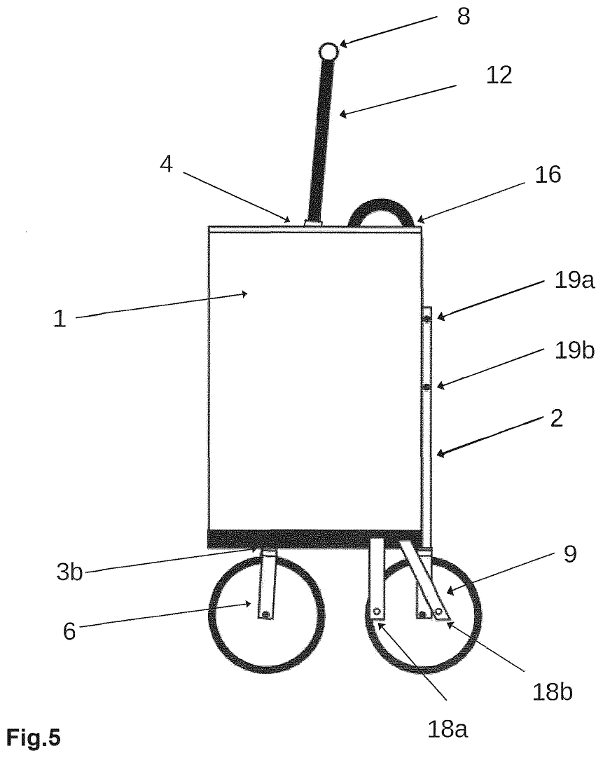

FIG. 6 shows a variant of the scooter according to the invention with a removable footrest in 3D view;

FIG. 7 shows the front wheel holder according to the invention in a front view;

FIG. 8 shows the front wheel holder according to the invention in 3D view;

FIG. 9 shows the steering column holder according to the invention in 3D view.

### DESCRIPTION

The present invention creates a scooter for transporting people and luggage, e.g. in the form of a scooter powered by physical force (pedal-scooter) or electrically powered (e-scooter).

The invention is basically concerned with two problems: firstly, the scooter should have a universal luggage holder for securing various passenger items such as suitcases or shopping bags, which are difficult or hardly possible to carry as a rucksack on the passenger's back.

On the other hand, a stable and compact structure weighing as little as possible should be created, which also makes the scooter itself as easy to carry as possible and yet enables the scooter to withstand the increased driving dynamic forces, particularly along the direction of travel.

This is solved by an elongated spatial frame 1 seen in the direction of travel, which absorbs the forces of the footrest 2, front wheel 3 and steering column 12 and integrates a luggage holder.

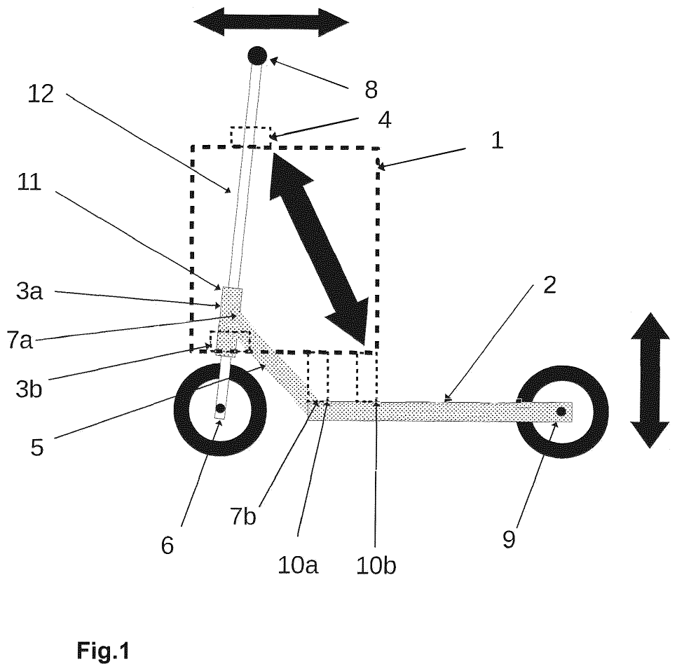

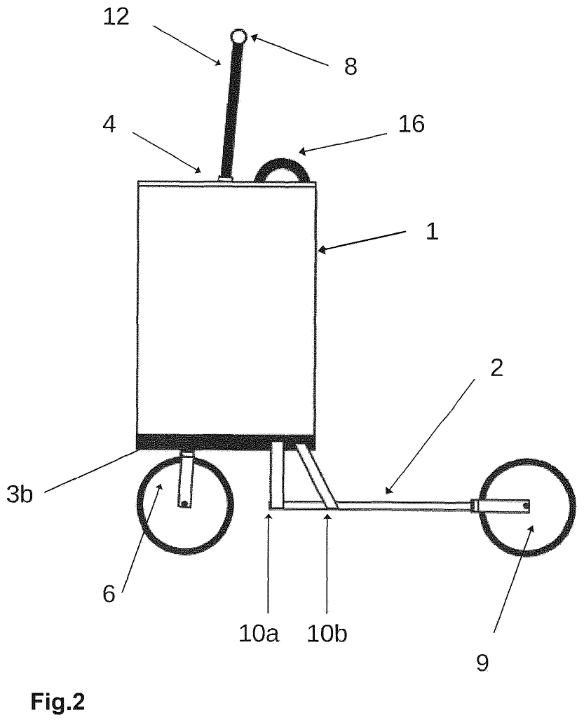

FIG. 1 shows schematically a pedal-scooter or electrically-powered e-scooter according to the prior art without a luggage holder or container. The dashed lines show components according to the invention that were projected into FIG. 1. FIGS. 2 ff. show the scooter only in the design according to the invention.

The scooter shown in FIG. 1 according to the prior art comprises the following components:

A front wheel fork 6, which is rotatably supported by means of a substantially vertically aligned tube 3a together with a steering column 8 at the front on a frame 1, which extends in the direction of travel and carries the footrest 12 and the rear wheel 9 behind one another.

The front wheel fork 6, which vertically supports the front wheel at the bottom and is closed at the upper side by a guide tube, is in the case of conventional scooters supported from below by a vertically aligned tube 3a as an externally surrounding sleeve-shaped guide bearing, which is also connected at the top to the steering column 12.

This guide bearing is usually connected to the footrest 2 via a cross member 5, the connections 7a of the cross member 5 to the front wheel and steering column holder 3a and to the footrest 2 being generally curved or angled and welded.

In the case of scooters powered by muscle power, the cross member 5 is often interrupted by a pivot bearing between the points 7a and 7b, in order to swivel the steering column 12 with the front wheel 6 and the footrest 2 with the rear wheel 9 towards one another in order to more easily carry and store the scooter in the collapsed state. In order to fix the swivel angle resulting from the end points 8 and 9 in the driving state and in the collapsed state, movable parts such as locking bolts are used that have a corresponding amount of play. This play is particularly perceptible to the driver due to the relatively long lever of the steering column.

This is due to the driver's upright position, which also requires that the footrest and/or the wheelbase have a sufficient length to ensure tipping stability about the axis transverse to the direction of travel.

Due to the weight of the driver (the vertical arrow shows the main direction of force) and when pulling on and pushing away the steering column 12 for accelerating and braking (the horizontal arrow in FIG. 1 shows the main direction of force), relatively large forces occur at points 7b and 7a and in between, especially with taller and heavier people.

These leverage forces are dynamically amplified by uneven ground and act as buckling forces and shear forces on the material, which must have high material thicknesses and robust joints (welds) that are complicated to produce. Also, any pivot bearings with fixing bolts and their sockets must be of robust construction. All of this increases the cost and weight of the scooter.

In the frame 1 according to the invention the area of the plane spanned by the points 8, 6, 9 between the force-absorbing points 4 and 10b is supported by a fully filling, planar structure, which is also referred to as support 13, on which the thrust and tensile forces (oblique arrow) act for the most part.

In addition, the lever lengths are shortened and accordingly the lever forces are reduced. Thus, on a steering column holder 4 according to the invention the force acting in the horizontal direction with, and against, the direction of travel via the steering column 12 only acts on the lever path 8-4. In contrast to this, in the prior art the same force acts on the lever path 8-11.

The vertical force components act according to the invention on the section 10b-9, and according to the prior art on the section 7b-9.

In addition, the counter levers counteracting the lever forces are extended. According to the prior art, this is limited to the width of the cross member 5 at points 7a and 7b.

According to the invention, the counter lever acting on the steering column 12 (horizontal force) is the section 3b-4, and that acting on the footrest 2 and rear wheel 9 (vertical force) is the section 10a-10b.

Both the shortening of the lever lengths and the lengthening of the counter levers relieve the load on the holders and frame parts, which can therefore be made lighter.

DE 11 2016 006 507 T5 and CN108791621A also suggest filling the angle with a hollow body, although the driver's feet are positioned to the side of the hollow body and not behind it, which means that it is not possible or advantageous to arrange a luggage rack on the hollow body.

In DE20018919U1 the steering column is held in a spatial container, but the sensitive cross member 5 is retained.

Scooter devices that are built around a suitcase (e.g. DE000010204478A1, DE202019103766U1, DE000008128047U1) clearly also benefit from this as a lever-shortening central frame, but however are aligned transversely to the direction of travel, while the strongest driving dynamic forces act lengthways in the direction of travel.

The frame 1 can be designed in the form of a space frame or as a monocoque.

One possible design is an elongated tubular frame, similar to a bicycle frame. The hollow spaces between the tubes can be covered with a fabric for example, for transporting small items of luggage.

According to the invention, a flat spatial volume body is used as the frame 1, which is preferably further reinforced on the lower edge and in the region of the holders 3b, 10a, 10b, 4, and is closed on at least one side surface. Drawers or compartments can be provided on the top and bottom to store valuables or, in the case of e-scooters, to hold the batteries.

The frame 1 comprises the support 13, which has a vertical surface and can also be referred to as “surface” for short, which is made of a rigid material and also serves on at least one side as a vertical luggage area with the most flexible securement possibilities-compared to the tubular frame—for example in the form of fixed hooks 17, eyelets or recesses for inserting various fixtures.

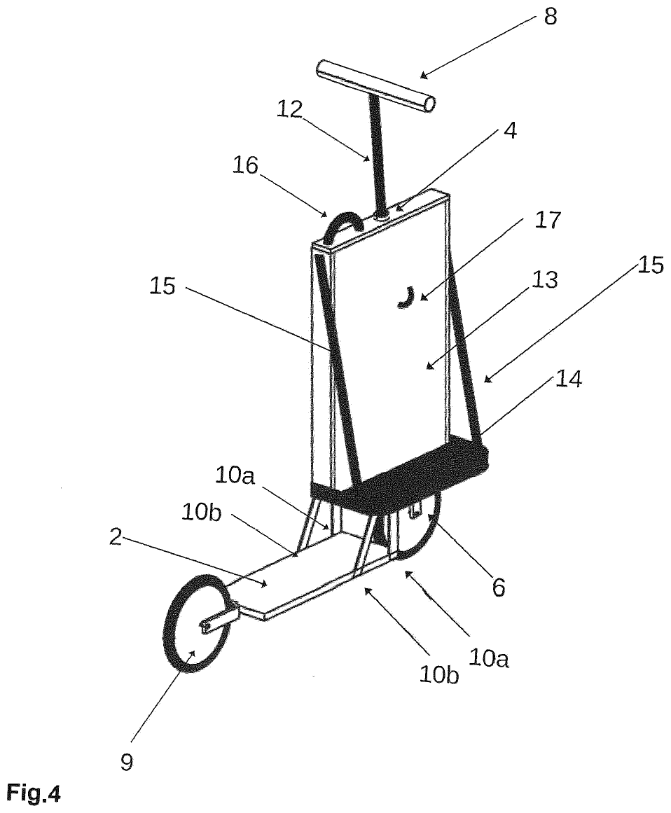

As FIG. 4 shows, the possibility of loading the frame 1 according to the invention with the vertical luggage area of the support 13 corresponds to a truck flatbed reduced in size rotated by 90 degrees.

Analogous to this truck flatbed, which becomes a container with the aid of a tarpaulin frame and tarpaulin, the invention can in a further implementation be used with various attachments and a cover, for example using clampable frame parts and fabric parts, to become a closed container for luggage.

An item of luggage, e.g. a suitcase, can also be permanently secured in the luggage area

Fastening elements, e.g. expanders, that are clamped to the outer edges of the luggage area can be used to secure the luggage, or fittings can be hooked into recesses in the surface, in order for example to attach solid items of luggage or to attach cross panels or to attach bags or suitcases to a hook 17 by means of loops.

According to the invention, the lower region of the vertical luggage area of the support 13 is provided with a horizontal floor platform 14, preferably with a floor board or sheet, to secure luggage downwards.

In addition, the centre of gravity of the entire vehicle shifts downwards when the load is placed on it. The lower centre of gravity makes it easier to balance when driving and increases stability against lateral tipping. The scooter can therefore be parked stably upright using the foot kickstand, even with luggage.

The horizontal floor platform 14 is preferably firmly integrated into the frame 1.

If the scooter is to be constructed rather narrow or the size of the load varies greatly, in further variants the horizontal floor platform 14 can be extended in several stages into the frame 1 or retracted for transport, or can be folded out and attached to the vertical luggage area of the support 13 for transport.

Additional removable or collapsible horizontal loading areas can be attached parallel to the horizontal floor platform 14 and above it.

For additional stability, according to the invention the vertical luggage area of the support 13 and the horizontal floor platform 14 are connected at least at the outer edges at the front and rear with cross members 15, which are preferably fixedly mounted.

However, these can also be designed to be removable, especially in the case of a movable floor platform.

According to the invention, a horizontally aligned holding device such as a stable handle or a holding loop 16 is attached to the upper side of the frame 1 so that the scooter can be lifted using one hand, for example to carry it over steps. The horizontal arrangement of the holding device according to the invention as close as possible to the centre of gravity of the base makes it easier to keep the scooter in as horizontal a position as possible.

A common problem with scooters, especially e-scooters that cannot be collapsed, is the space required for parking.

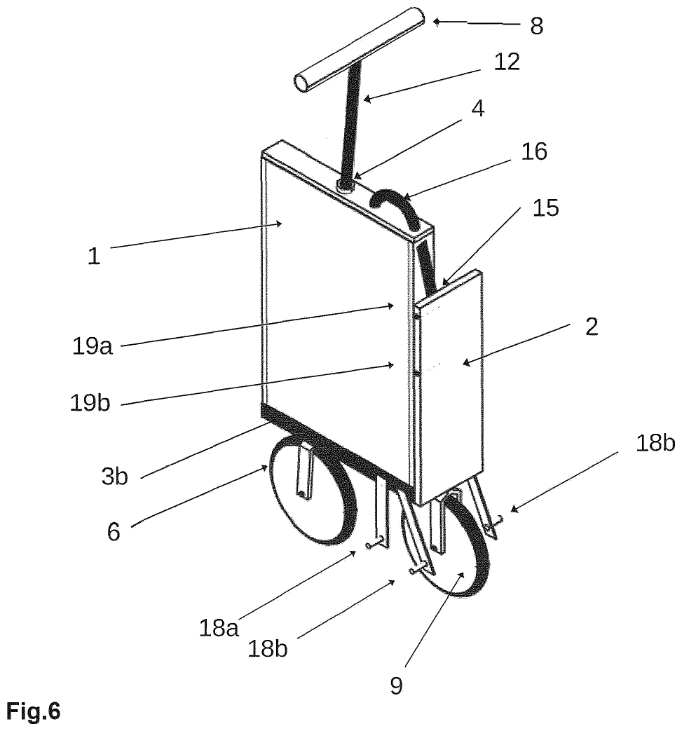

In a variant of the invention (FIG. 6), the footrest 2 together with the rear wheel 9 can be removed from the frame 1 and attached to the back of the frame 1 with the rear wheel 9 facing downwards.

This thereby significantly reduces the floor space when parking and road dirt remains with the wheels on the ground. Nevertheless, the scooter can still be pushed and moved even in the collapsed state.

For this purpose, the support struts 10a, 10b of the footrest 2 on the frame 1 are provided with pull-out bolts 18a, 18b that connect the underside of the support struts 10a, 10b to the footrest 2, which hold them in drilled cylindrical hollow sockets 19a, 19b.

The footrest 2 is fixed to the frame 1 by means of fittings or, according to the invention, by magnetic surfaces on the underside of the footrest 2 and the outside of the rear cross member 15.

The underside of the frame 1 in the implementation according to the invention is suitable for attaching fold-out kickstands, which can also be used when the footrest 2 is folded up.

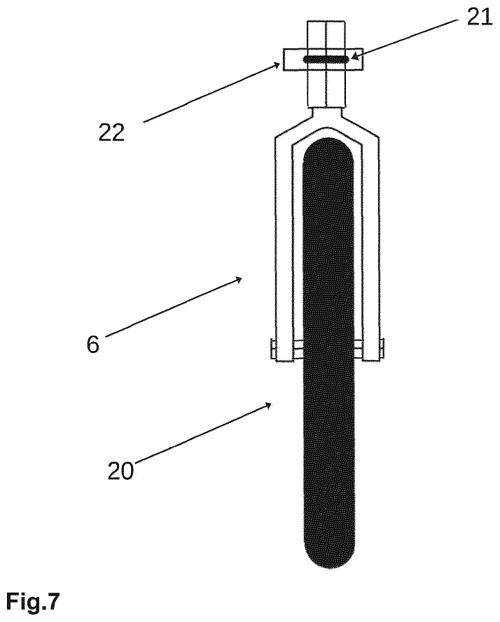

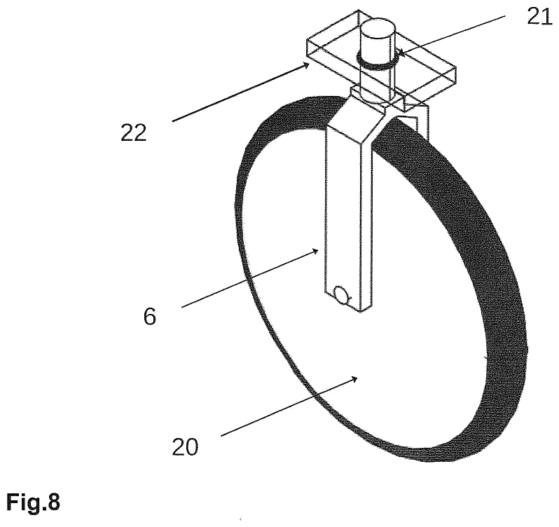

FIGS. 7 and 8 show the front wheel holder 3b according to the invention. The front wheel fork 6 opens out into a rotatable vertical tube, which is enclosed via a pivot bearing 21 by a stationary holding block 22 (also referred to as a “holder” 22), which is preferably installed as a separate part on the underside of the frame 1 or is an integral part thereof.

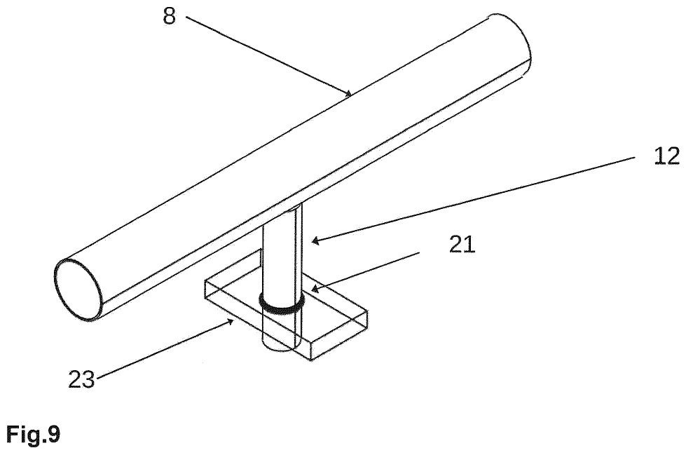

FIG. 9 shows the steering column holder 4 according to the invention. The steering column 12 is preferably arranged flush concentrically above the front wheel fork 6 and is coupled to it in a frictional manner. Alternatively, the steering column 12 can be arranged offset to the front wheel fork 6 and connected to it via a drive device, for example a chain drive.

The steering column holder 4 is rotatably enclosed via a pivot bearing 21a by a stationary holding block 23, which is preferably installed as a separate part on the upper side of the frame 1 or is an integral part thereof.

In a single-track vehicle with a frame (1), on which are mounted at least one rear wheel (9) by means of a rear wheel holder of the frame (1), as well as a steering column (12) and a front wheel fork (6) with a front wheel holder (3b) for a front wheel (20) steered by means of the steering column (12) by means of at least one holder (4; 22) having at least one pivot bearing, and the frame of which has a footrest (2), wherein a handle part (8) with which the person steers the vehicle is attached to the steering column (12), and the steering column (12) and the front wheel fork (6) are directly or indirectly coupled to one another, wherein the handle part (8) is firmly connected to the steering column (12), and

the frame (1) is designed so it can be extended lengthways in the direction of travel, the frame (1) has at least one support (13) made of a rigid material and comprising a vertical surface, which extends in the longitudinal direction of the vehicle, and which is arranged in the region of the steering column (12) or between the steering column (12) and the footrest (2) above the footrest (2). A front fork holder (22) for the front wheel fork (6) is provided in the region of a lower edge of the support (13), and a steering column holder (4) for the steering column (12) is provided in the region of an upper edge of the support (13). The footrest (2) extends further rearwards in relation to the direction of travel than the support (13), and the front fork holder (22) and the steering column holder (4) only allow rotational movements of the front wheel fork (6) and the steering column (12) relative to the frame (1), and the support (13) absorbs forces acting horizontally on the front wheel fork (6) and the steering column (12). The footrest (2) is connected to a rear, lower region of the support (13).

### LIST OF REFERENCE NUMERALS

1 Frame
2 Footrest
3a Front wheel holder and steering column holder according to the prior art
3b Front wheel holder according to the invention
4 Steering column holder according to the invention
5 Cross member connecting the front wheel to the steering column and footrest, according to the prior art
6 Front wheel fork
7a Connection point of 5 and 3a according to the prior art
7b Connection point of 5 and 2 according to the prior art
8 Handle part
9 Rear wheel
10a Front holding struts of the footrest on the frame according to the invention
10b Rear holding struts of the footrest on the frame according to the invention
11 Steering column holder according to the prior art
12 Steering column
13 Support with vertical luggage area
14 Horizontal floor platform
15 Cross members
16 Holding loop
17 Hook
18a Front pull-out bolt
18b Rear pull-out bolt
19a Socket for front pull-out bolt
19b Socket for rear pull-out bolt
20 Front wheel
21, 21a Pivot bearing
22 Front fork holder connection block
23 Steering column holder connection block

1. Single-track vehicle with a frame (1) on which are mounted at least one rear wheel (9) by means of a rear wheel holder of the frame (1) as well as a steering column (12) and a front wheel fork (6) with a front wheel holder (3b) for a front wheel (20) steered by means of the steering column (12) by means of at least one holder (4; 22) having at least one pivot bearing;
wherein a person can be transported standing on a footrest (2) of the frame (1) arranged between the front wheel (20) and the rear wheel (9),
wherein a handle part (8) with which the person steers the vehicle is attached to the steering column (12),
wherein the steering column (12) and the front wheel fork (6) are directly or indirectly coupled to one another,
the handle part (8) is firmly connected to the steering column (12), and
the frame (1) is designed to be extended lengthways in the direction of travel
characterized in that
the frame (1) comprises at least one support (13) made of a rigid material and having a vertical surface, which can be used as a luggage rack and extends in the longitudinal direction of the vehicle and which is arranged in the region of the steering column (12) or between the steering column (12) and the footrest (2) above the footrest (2),
a front fork holder (22) for the front wheel fork (6) is provided in the region of a lower edge of the support (13), and a steering column holder (4) for the steering column (12) is provided in the area of an upper edge of the support (13), and
the footrest (2) extends further rearwards than the support (13) in relation to the direction of travel,
and the front fork holder (22) and the steering column holder (4) only allow rotational movements of the front wheel fork (6) and of the steering column (12) relative to the frame (1) and the support (13) absorbs forces acting horizontally on the front wheel fork (6) and the steering column (12), and the footrest (2) is connected to a rear, lower area of the support (13).

2. Vehicle according to claim 1, characterized in that the front fork holder (22) and the steering column holder (4) are each designed as pivot bearings.

3. Vehicle according to claim 1, characterized in that the support (13) is made geometrically so dense and so stable that items of luggage can be attached to it without falling through in the horizontal direction.

4. Vehicle according to claim 3, characterized in that the support (13) provides for example on its surface at least two fixing possibilities (17) by means of which items of luggage can be secured.

5. Vehicle according claim 1, characterized in that the surface of the support (13) is closed off at its lower end by at least one floor platform (14) running horizontally towards the side, on which luggage can be supported.

6. Vehicle according to claim 1, characterized in that a stand is attached near the rear, lower corner of the support (13).

7. Vehicle according to claim 1, characterized in that the footrest (2) together with the rear wheel (9) is designed to be removable, and fastening means are provided on the support (13) for vertically attaching the footrest (2) parallel to the rear edge on the outside of the surface with the rear wheel facing downwards.

8. Vehicle according to claim 1, characterized in that a horizontally aligned holding device, a robust handle or a holding loop (16) is attached to the upper edge of the support (13).

9. Vehicle according to claim 5, characterized in that cross members (15) are arranged between the outer corners of the floor platform and the upper ends of the front and rear side edges of the support (13).

10. Vehicle according to claim 1, characterized in that holders for mobile phones or maps or bottle holders are attached to the upper edge of the support (13).

11. Vehicle according to claim 1, characterized in that lockable compartments are arranged on the support (13).

12. Vehicle according to claim 1, characterized in that the vehicle has an electric drive and batteries are secured to the support (13).

13. Vehicle according to claim 1, characterized in that advertising images and/or advertising inscriptions are applied to one or both side surfaces of the support (13).
